(19) United States
(12) Patent Application Publication
(10) Pub. No.: US 2014/0208976 A1
(43) Pub. Date: Jul. 31, 2014

(54) DRIVING WHEEL OF ROBOT MOVING ALONG THE WIRE AND ROBOT HAVING THE SAME

(71) Applicant: KOREA INSTITUTE OF SCIENCE AND TECHNOLOGY, Seoul (KR)

(72) Inventors: Byeong In JUNG, Seoul (KR); Chang Hwan KIM, Seoul (KR); Taikjin LEE, Seoul (KR); Jae Hun KIM, Busan (KR); Seok LEE, Seoul (KR); Sung Kee PARK, Seoul (KR)

(73) Assignee: KOREA INSTITUTE OF SCIENCE AND TECHNOLOGY, Seoul (KR)

(21) Appl. No.: 14/167,340

(22) Filed: Jan. 29, 2014

(30) Foreign Application Priority Data
Jan. 29, 2013 (KR) 10-2013-0009848

(51) Int. Cl. H02G 1/02; B61B 3/02; B60B 17/00

(52) U.S. Cl. CPC H02G 1/02; B60B 17/0089; B61B 3/02; Y10S 901/44; Y10S 901/01
USPC 104/112; 295/1; 901/44; 901/1

(57) ABSTRACT

A driving wheel of a robot moving along a wire includes an inner wheel in which a rotation axis being driven to rotate by a motor is fitted, an outer wheel formed to surround the inner wheel and seated on the wire, and a shock absorbing support to elastically connect and support the inner wheel and the outer wheel between the inner wheel and the outer wheel, and a shock being transmitted is absorbed by allowing a relative movement of the inner wheel and the outer wheel by the elastic movement of the shock absorbing support. A robot moving includes a robot body, the driving wheel, a motor to drive the driving wheel by rotating the rotation axis, a connecting arm to connect and support the driving wheel and the robot body.

### CROSS-REFERENCE TO RELATED APPLICATION

This application claims priority to Korean Patent Application No. 10-2013-0009848, filed on Jan. 29, 2013, and all the benefits accruing therefrom under 35 U.S.C. §119, the contents of which in its entirety are herein incorporated by reference.

### BACKGROUND

1. Field

The present disclosure relates to a driving wheel of a robot moving along a wire and a robot having the same, and more particularly, to a driving wheel of a robot moving in orbit along an elongated wire such as a transmission line and a robot having the same.

2. Description of the Related Art

With the development of industries, use of electricity is increasing. To meet the fast growing demand for electric power, power generation plants and transmission lines are continuously being built. Along with this, there is a trend toward emphasizing the significance of inspection and maintenance tasks of a transmission line specialized to carry electricity generated from a power generation plant to a source of demand.

Currently, transmission line inspection mainly relies on visual inspection by a skillful technician who goes up to a transmission line in person and inspects the transmission line with the naked eye, and has a very high risk of safety accidents or like. To reduce the risk, a transmission line inspection robot is used. The transmission line inspection robot has mostly a structure of moving along a transmission line in a similar manner to a cable car.

FIG. 1 is a schematic diagram illustrating a transmission line inspection robot according to a related art. FIG. 1 shows a transmission line inspection robot 10 moving on a 4 conductor transmission line 1.

The transmission line inspection robot 10 includes a robot body 11, a connecting arm 12 extending from the robot body 11, and a driving wheel 13 connected to a top of the respective connecting arm 12. The driving wheel 13 is connected to a motor 15 and is driven to rotate by the motor 15. As the driving wheel 13 is driven to rotate, the robot 10 moves along the transmission line 1.

Generally, the driving wheel 13 is equipped with a wire reception groove 14 having a width corresponding to a diameter of the transmission line 1. The reception groove 14 designed to receive the transmission line 1 prevents the driving wheel 13 from easily moving out of the transmission line 1.

However, a metal fitting is generally provided in the middle of the bundled conductor transmission line 1, for example, a space damper 2 configured to maintain spacing between wires. Besides the space damper 2, a compression connecting sleeve may be provided on the transmission line to make a compression connection of wires.

Because a majority of metal fittings have a greater cross-sectional area than the transmission line 1, the metal fittings can be an obstacle to mobility of the robot 10.

The driving wheel for the transmission line inspection robot according to the related art has a quite limited contact area with the transmission line, and when the robot 10 moves beyond an obstacle having a larger diameter than the transmission line 1, the risk of the robot 10 running off the transmission line 1 is very high.

Also, the conventional driving wheel has no shock-absorbing function, and thus, when the transmission line 1 sways violently due to external disturbance such as a strong wind or for other reasons, there is a high risk of going off the transmission line 1, and when the driving wheel 13 penetrates the metal fitting 2 causing obstruction, the metal fitting 2 may be affected by a shock and damaged, resulting in frequent repair or replacement of the metal fitting.

### SUMMARY

The present disclosure is directed to providing a driving wheel that enables a robot moving along a wire such as a transmission line inspection robot to stably move on the wire and a robot having the same.

In one aspect, there is provided a driving wheel of a robot moving along a wire, the driving wheel including an inner wheel in which a rotation axis being driven to rotate by a motor is fitted, an outer wheel formed to surround the inner wheel and seated on the wire, and a shock absorbing support to elastically connect and support the inner wheel and the outer wheel between the inner wheel and the outer wheel, and a shock being transmitted is absorbed by allowing a relative movement of the inner wheel and the outer wheel by the elastic movement of the shock absorbing support.

According to an exemplary embodiment, the outer wheel may be made from an elastic material, and when an external force is applied, the outer wheel may change in shape in response to the external force, and when the external force is removed, restore the shape.

The shock absorbing support may include a plurality of spokes made from an elastic material to apply elastic power in a radially outward direction of the outer wheel, and when an external force is applied, the shock absorbing support may change in shape in response to the external force, and when the external force is removed, restore the shape.

The spokes may be formed in a slanted manner with respect to a normal line tangent to an outer surface of the inner wheel.

The outer wheel may have a wire reception groove formed along a circumstance of an outer surface of the outer wheel to prevent separation of the wire.

The inner wheel, the outer wheel, and the shock absorbing support may be integrally formed.

In another aspect, there is provided a robot moving along a wire, the robot including a robot body, the driving wheel, a motor to drive the driving wheel by rotating the rotation axis, and a connecting arm to connect and support the driving wheel and the robot body, and as the driving wheel is driven to rotate on the wire by the motor, the robot moves along a lengthwise direction of the wire.

According to an exemplary embodiment, the robot may be a transmission line inspection robot to inspect the condition of a transmission line while moving along a lengthwise direction of the transmission line, and the robot may include an inspection device to inspect the transmission line.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a conceptual diagram of a transmission line inspection robot according to a related art;

FIG. 2 illustrates a transmission line inspection robot according to an exemplary embodiment;

FIG. 3 is a perspective view of a driving wheel according to an exemplary embodiment;

FIG. 4 is a side view of the driving wheel of FIG. 3;

FIG. 5 is a front view of the driving wheel of FIG. 3;

FIGS. 6A and 6B illustrates a driving wheel seated on a transmission line according to an exemplary embodiment; and

FIGS. 7A and 7B illustrate the driving wheel of FIG. 6 in contact with a metal fitting causing obstruction.

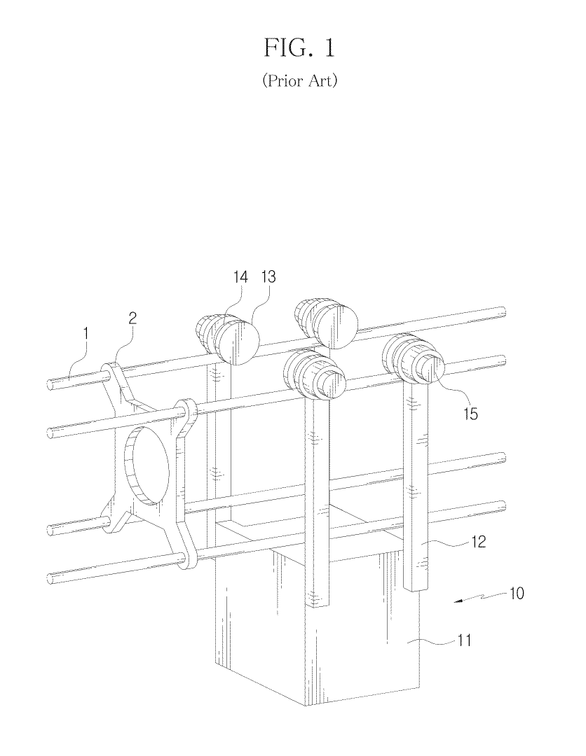

### DETAILED DESCRIPTION

Hereinafter, preferred embodiments are described with reference to the accompanying drawings. The present disclosure is described with reference to the exemplary embodiments set forth therein, but this is for illustrative purposes only and not intended to limit the technical scope of the present disclosure and the essential features and functions herein.

While a transmission line inspection robot is described below as an embodiment of the present disclosure, it should be understood that the technical idea of the invention can be applied to various types of moving robots designed to move along a wire.

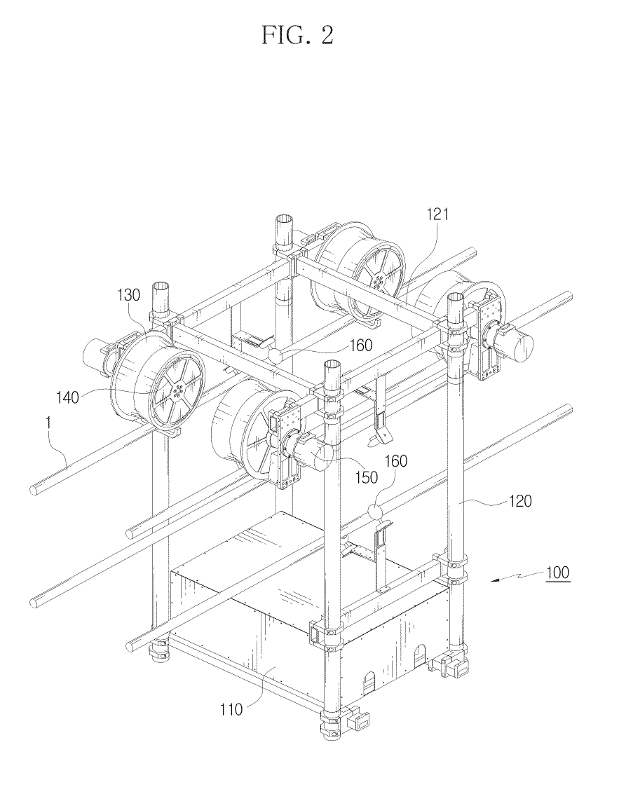

FIG. 2 illustrates a transmission line inspection robot 100 according to an exemplary embodiment.

Referring to FIG. 2, the transmission line inspection robot 100 according to this embodiment moves on a 4 conductor transmission line 1. The 4 conductor transmission line 1 is formed of a four stranded wire, and generally, the four stranded wire has a square array when viewed from the front.

The transmission line inspection robot 100 according to this embodiment includes a robot body 110, a driving wheel 130 seated on the transmission line 1, a motor 150 to drive the driving wheel 130 to rotate, and a vertical connecting arm 120 extending vertically in the vicinity of four edges of the robot body 110 and a horizontal connecting arm 121 to fix the vertical connecting arm 120 and support the driving wheel 130 and the motor 150.

Also, the transmission line inspection robot 100 includes an x-ray equipment 160 to inspect the inside of the transmission line 1. Although not shown, the transmission line inspection robot 100 may further include a transmission line inspecting device disposed in front of the driving wheel in a forward direction of the robot 100 to observe the outside of transmission line 1, for example, a camera, as well as the X-ray equipment 160. The configuration and function of the transmission line inspection device is well known in the art, and thus its specific description is omitted herein.

The robot body 110 has a shape of a box, and receives a communication equipment for external communication and a battery and various types of control devices necessary for operation of the robot therein.

The respective vertical connecting arm 120 extends vertically from the robot body 110, and extends above the wires located at the upper part among the four wires. The vertical connecting arm 120 according to this embodiment is placed outside the transmission line 1.

The horizontal connecting arm 121 of a generally quadrilateral “ [symbol] ” shape is provided at the top of the vertical connecting arm 120 to support and fix the four vertical connecting arms 120.

Also, the driving wheel 130 is coupled with the motor 150 in the vicinity of the four edges of the horizontal connecting arm 121.

The driving wheel 130 is connected to a rotation axis (not shown) of the motor 150, and as the rotation axis rotates by the motor 150, the driving wheel 130 rotates. The rotation axis is arranged perpendicular to the forward direction of the robot 100.

As shown in FIG. 2, a pair of the driving wheels 130 arranged in the forward direction of the robot is laid on the upper two wires among the 4 conductors. When the motor 150 drives the driving wheel 130 to rotate, the robot 100 moves on the transmission line 1 along a lengthwise direction of the transmission line 1. A cover 140 is provided at both sides of the driving wheel 130 to protect the driving wheel 130 from an external impact.

The transmission line inspection robot 100 according to this embodiment includes the driving wheel 130 with the improved structure for stably traveling on the transmission line.

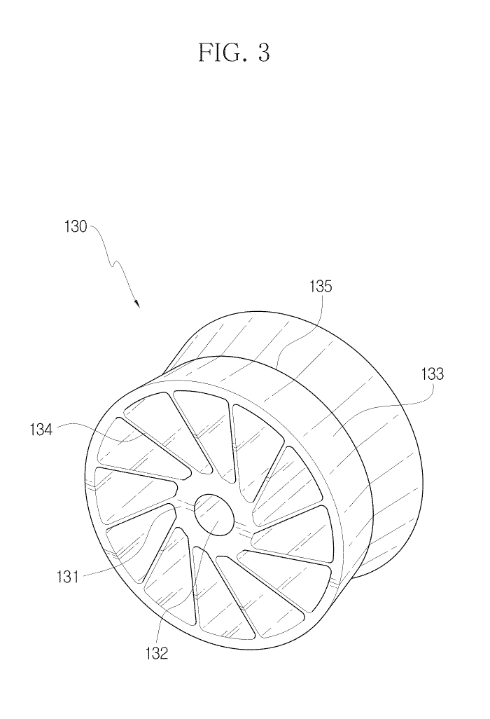

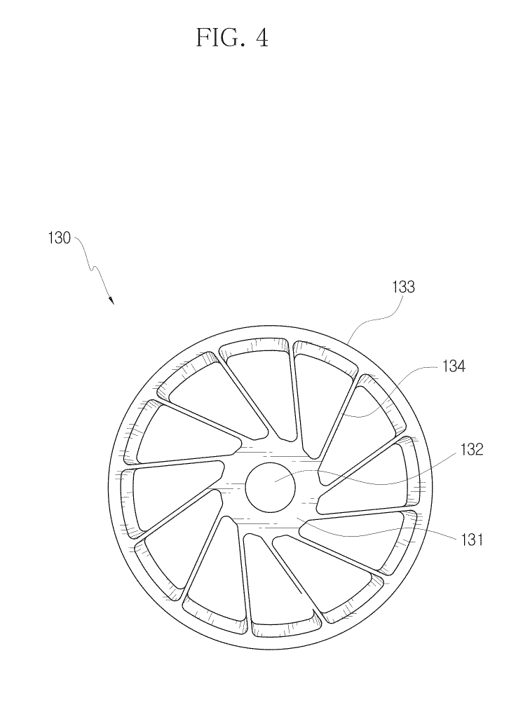

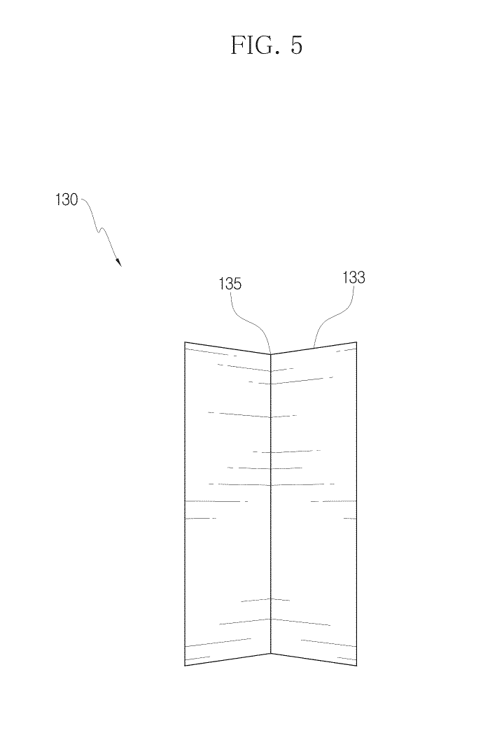

FIG. 3 is a perspective view of the driving wheel 130 according to this embodiment, FIG. 4 is a side view of the driving wheel 130, and FIG. 5 is a front view of the driving wheel 130.

As shown in FIGS. 3 through 5, the driving wheel 130 according to this embodiment includes an inner wheel 131, an outer wheel 133 having a larger diameter than the inner wheel 131 and surrounding the inner wheel 131 outside the inner wheel 131, and a shock absorbing support 134 interposed between the inner wheel 131 and the outer wheel 133 to connect and support the inner wheel 131 and the outer wheel 133. According to this embodiment, the inner wheel 131, the outer wheel 133, and the shock absorbing support 134 are made from polyurethane and integrally formed through mold forming.

The inner wheel 131 is a part in which the rotation axis (not shown) connected to the motor 150 is fitted, and has a locking hole 132 formed therethrough at the center in which the rotation axis may be inserted.

The outer wheel 133 is a part that is seated on the wire, that is, the transmission line 1. As seen in FIG. 5 best, according to this embodiment, the outer wheel 133 is shaped such that a cross-sectional area gradually increases from a circumferential center to both sides thereof when viewed from the front. Accordingly, the outer wheel 133 has a wire reception groove 135 of an overall “v” shape on an outer surface thereof, in which the transmission line 1 is received. The wire reception groove 135 serves to prevent the transmission line 1 from separating from the driving wheel 130.

According to this embodiment, the outer wheel 133 has an elastic property, and is deformed when an external force is applied and returns to an original shape when the external force is removed, as described below.

The shock absorbing support 134 is formed of a plurality of spokes slanted at a predetermined angle with respect to a normal line (not shown) that is tangent to an outer surface of the inner wheel 131, as seen in FIG. 4 best.

The plurality of spokes is made from an elastic material, similar to the outer wheel 133, and provides elastic power in a radially outward direction of the outer wheel 133. As described below, the shock absorbing support 134 is configured to deform when an external force is applied, and elastically connects and supports the outer wheel 133 and the inner wheel 131.

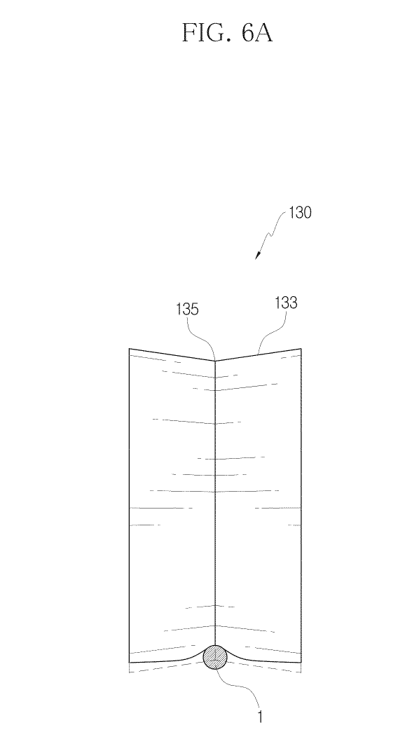

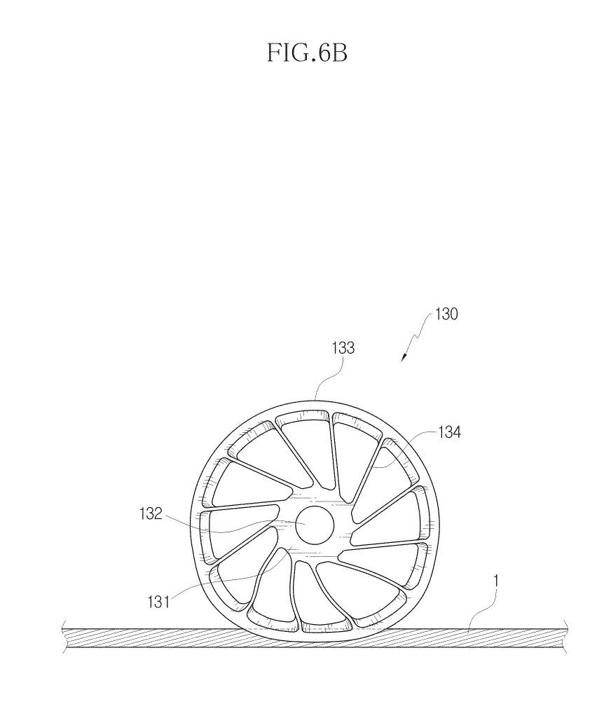

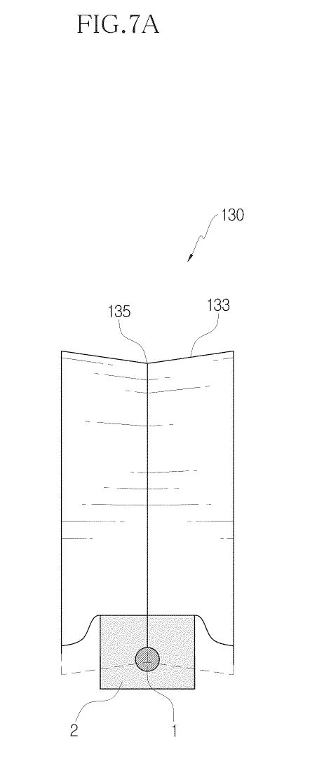

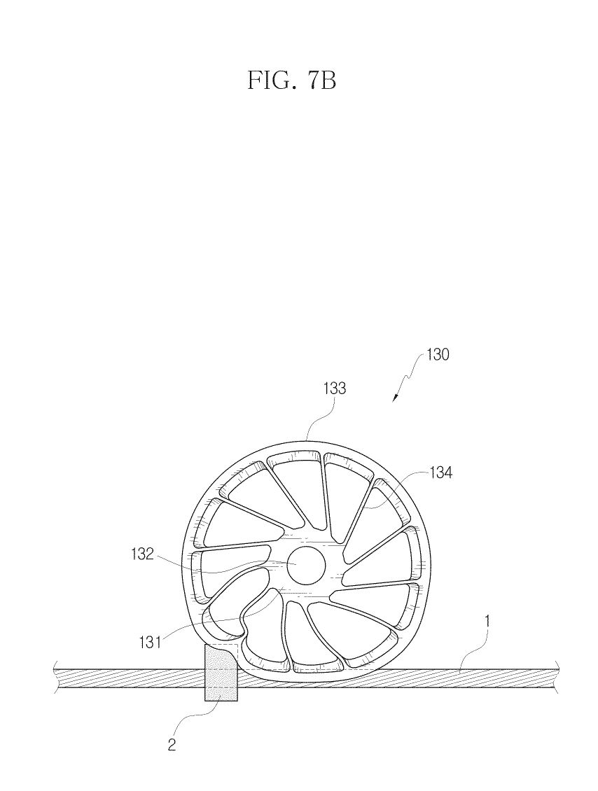

Hereinafter, the improved features of the driving wheel 130 according to this embodiment are described in more detailed with reference to FIGS. 6A, 6B, 7A and 7B.

FIGS. 6A and 6B illustrate the transmission line inspection robot 100 seated on the transmission line 1, and FIGS. 7A and 7B illustrate the transmission line inspection robot 100 in contact with the metal fitting 2 causing obstruction. In FIGS. 6A, 6B, 7A and 7B, illustration of other elements of the robot than the driving wheel 130 is omitted herein for the convenience of illustration.

As described in the foregoing, according to this embodiment, the outer wheel 133 and the shock absorbing support 134 are made from an elastic material that causes a change in shape when an external force is applied.

Accordingly, as shown in FIG. 6A and 6B, when the robot 100 is seated on the transmission line 1, the outer wheel 133 having an original substantially circular shape is deformed to the inner wheel 131 by the weight of the robot 100, and the shock absorbing support 134 extending substantially linearly is bent to a proper shape. In response to an external force (reaction force to gravity) being applied to the driving wheel 130 by the transmission line 1, the outer wheel 133 and the shock absorbing support 134 are deformed.

As seen in FIG. 6A best, with the deformation of the outer wheel 133, the wire reception groove 135, in which the transmission line 1 is received, increases in depth and the outer wheel 133 surrounds the transmission line 1 on the left and right sides, thereby effectively preventing the transmission line 1 from departing from the driving wheel 130.

In such state as shown in FIGS. 6A and 6B, when the robot 100 moves forward by the rotation of the driving wheel 130, a portion released from the contact with the transmission line 1 returns to its original shape due to the external force being removed, and a portion newly coming in contact with the transmission line 1 is deformed by the weight of the robot 100.

Meanwhile, as shown in FIGS. 7A and 7B, when the driving wheel 130 comes in contact with the metal fitting 2 that can be an obstacle on the transmission line, a portion coming in contact with the metal fitting 2 is additionally deformed, and the shock absorbing support 134 supporting the corresponding portion is bent and deformed to a proper shape. As the robot 100 goes past, the deformed portion subject to the contact of the robot 100 with the obstacle returns to the shape before the contact with the obstacle.

According to the above configuration, because the shock absorbing support 134 elastically supports the outer wheel 133 and the inner wheel 131, a relative location of the outer wheel 133 and the inner wheel 131 is not fixed and allows for appropriate modifications based on a magnitude and a location of the external force. Accordingly, when faced with external disturbance caused by the sway of the transmission line 1 by wind and the like, the outer wheel 133 can move in response to the sway of the transmission line 1 due to the shock absorption effect by the elastic deformation of the shock absorbing support 134, thereby preventing the driving wheel 130 from easily moving out of the transmission line 1 and the sway of the transmission line 1 from being transmitted to the robot body 110.

Also, the outer wheel 133 is compressed into contact with the transmission line 1 to a proper extent corresponding to the weight of the robot 100, so that the contact area between the transmission line 1 and the driving wheel 130 significantly increases in comparison to the related art. Accordingly, the robot 100 may work on the transmission line 1 very stably.

Further, when the driving wheel 130 comes in contact with the metal fitting 2 causing obstruction, the outer wheel 133 of the driving wheel 130 may be deformed properly in response to a shape or height of the metal fitting 2, thereby preventing from the metal fitting 2 from being damaged due to a shock applied to the metal fitting 2 by the driving wheel 130, resulting in significant cost savings in the maintenance and repair of the transmission line 1.

What is claimed is:

1. A driving wheel of a robot moving along a wire, the driving wheel comprising:
an inner wheel in which a rotation axis being driven to rotate by a motor is fitted;
an outer wheel formed to surround the inner wheel and seated on the wire; and
a shock absorbing support to elastically connect and support the inner wheel and the outer wheel between the inner wheel and the outer wheel,
wherein a shock being transmitted is absorbed by allowing a relative movement of the inner wheel and the outer wheel by the elastic movement of the shock absorbing support.

2. The driving wheel according to claim 1, wherein the outer wheel is made from an elastic material, and when an external force is applied, the outer wheel changes in shape in response to the external force, and when the external force is removed, restores the shape.

3. The driving wheel according to claim 1, wherein the shock absorbing support comprises a plurality of spokes made from an elastic material to apply elastic power in a radially outward direction of the outer wheel, and when an external force is applied, the shock absorbing support changes in shape in response to the external force, and when the external force is removed, restores the shape.

4. The driving wheel according to claim 3, wherein the spokes are formed in a slanted manner with respect to a normal line tangent to an outer surface of the inner wheel.

5. The driving wheel according to claim 1, wherein the outer wheel has a wire reception groove formed along a circumstance of an outer surface of the outer wheel to prevent separation of the wire.

6. The driving wheel according to claim 1, wherein the inner wheel, the outer wheel, and the shock absorbing support are integrally formed.

7. A robot moving along a wire, the robot comprising:
a robot body;
a driving wheel defined in claim 1;
a motor to drive the driving wheel by rotating the rotation axis; and
a connecting arm to connect and support the driving wheel and the robot body,
wherein as the driving wheel is driven to rotate on the wire by the motor, the robot moves along a lengthwise direction of the wire.

8. The robot according to claim 7, wherein the robot is a transmission line inspection robot to inspect the condition of a transmission line while moving along a lengthwise direction of the transmission line, and the robot comprises an inspection device to inspect the transmission line.
